(19) United States
(12) Patent Application Publication
(10) Pub. No.: US 2026/0138456 A1
(43) Pub. Date: May 21, 2026

(54) POWER CONVERSION SYSTEM

(71) Applicant: TOYOTA JIDOSHA KABUSHIKI KAISHA, Toyota-shi (JP)

(72) Inventor: Tetsuhisa SAKAMOTO, Kasugai-shi (JP)

(73) Assignee: TOYOTA JIDOSHA KABUSHIKI KAISHA, Toyota-shi (JP)

(21) Appl. No.: 19/261,221

(22) Filed: Jul. 7, 2025

(30) Foreign Application Priority Data
Nov. 15, 2024 (JP) 2024-199765

(51) Int. Cl. B60L 1/00; B60L 58/14; H02J 7/00; H02M 7/68

(52) U.S. Cl. CPC B60L 1/006; B60L 58/14; H02J 7/855; H02M 7/68; B60L 2210/30; B60L 2210/40

(57) ABSTRACT

A power conversion system includes a power receiving port, a power supply port, a power conversion device that converts power received by the power receiving port to charge a power storage device of a vehicle or converts power of the power storage device to supply the power to the power supply port, a first switch that is provided in a first power supply line extending from the power receiving port to the power conversion device, a second switch that is provided in a second power supply line extending from the first power supply line to the power supply port and is opened and closed in complement with the first switch, and a control device. The control device generates a control signal for controlling operation states of both the first switch and the second switch.

### CROSS-REFERENCE TO RELATED APPLICATION

This application claims priority to Japanese Patent Application No. 2024-199765 filed on Nov. 15, 2024. The disclosure of the above-identified application, including the specification, drawings, and claims, is incorporated by reference herein in its entirety.

### BACKGROUND

### 1. Technical Field

The present disclosure relates to a power conversion system.

### 2. Description of Related Art

Japanese Unexamined Patent Application Publication No. 2015-142409 (JP 2015-142409 A) discloses a vehicle. The vehicle includes an inlet, a charger, a charging relay, a power storage device, an in-vehicle outlet, and a direct current (DC)/alternating current (AC) inverter. The inlet is a power receiving port that receives supply power from an external power supply. The charger converts the received supply power to charge the power storage device in a case where the charging relay is in a closed state (external charging). The in-vehicle outlet is a power supply port to which electric equipment is connected. The DC/AC inverter converts power of the power storage device to supply the converted power to the power supply port as discharge power. The DC/AC inverter is operated after a voltage of its output node is confirmed to be 0 V in order to avoid a collision between charge power and the discharge power.

### SUMMARY

A vehicle may include a power conversion device that is bidirectional and is capable of executing, using the single power conversion device, both a function of external charging and a function of power supply to outside the vehicle. In this case, a first switch may be provided in a first power supply line extending from a power receiving port to the power conversion device, and a second switch may be provided in a second power supply line extending from the first power supply line to a power supply port. During external charging, the first switch may be controlled to be in a closed state to maintain the first power supply line in a conducting state, and the second switch may be controlled to be in an open state to bring the second power supply line into a non-conducting state. This is to suppress unintentional application of a voltage of supply power to electric equipment due to electrical connection between the power receiving port and the power supply port. The electrical connection occurs because a voltage of the supply power often differs from an operating voltage of the electric equipment.

Meanwhile, in a case where an abnormality occurs in a control system that controls the second switch, the second switch may malfunction during external charging and may be unintentionally closed. As a result, there is a possibility that both the first and second power supply lines are in a conducting state, and the power receiving port and the power supply port are electrically connected. In this case, there is a possibility that the voltage of the supply power is unintentionally applied to the electric equipment.

The present disclosure has been made to solve the above problems. The present disclosure provides a power conversion system capable of suppressing, even in a case where an abnormality occurs in a control system of a vehicle, unintentional application of a voltage of supply power from outside the vehicle to electric equipment connected to a power supply port of the vehicle.

A power conversion system of the present disclosure is mounted on a vehicle. The power conversion system includes a power receiving port, a power supply port, a power conversion device that is bidirectional, a first switch, a second switch, and a control device. The power receiving port receives power supplied from outside the vehicle. Electric equipment is connected to the power supply port. The power conversion device converts the power received by the power receiving port to charge a power storage device of the vehicle or converts power of the power storage device to supply the power to the power supply port. The first switch is provided in a first power supply line extending from the power receiving port to the power conversion device. The second switch is provided in a second power supply line extending from a portion of the first power supply line between the first switch and the power conversion device to the power supply port. The second switch is opened and closed complementarily to the first switch. The control device generates a first control signal for controlling operation states of both the first switch and the second switch.

According to the present disclosure, even in a case where an abnormality occurs in a control system of a vehicle, it is possible to suppress unintentional application of a voltage of supply power from outside the vehicle to electric equipment connected to a power supply port of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall configuration diagram of a vehicle on which a power conversion system according to an embodiment is mounted;

FIG. 2 is an overall configuration diagram of a vehicle on which a power conversion system according to the embodiment is mounted;

FIG. 3 is an overall configuration diagram of a vehicle on which a power conversion system according to the embodiment is mounted;

FIG. 4 is an overall configuration diagram of a vehicle on which a power conversion system according to the embodiment is mounted;

FIG. 5 is a diagram for describing an example of the transition of the signal value of the control signal and the open or closed state of the contact relay; and

FIG. 6 is a diagram for describing another example of the transition of the signal value of the control signal and the open or closed state of the contact relay.

### DETAILED DESCRIPTION OF EMBODIMENTS

Hereinafter, an embodiment of the present disclosure will be described in detail with reference to the drawings. The same or corresponding parts in the drawings are denoted by the same reference numerals, and the description thereof will not be repeated. Each of the embodiments and modifications may be appropriately combined with each other.

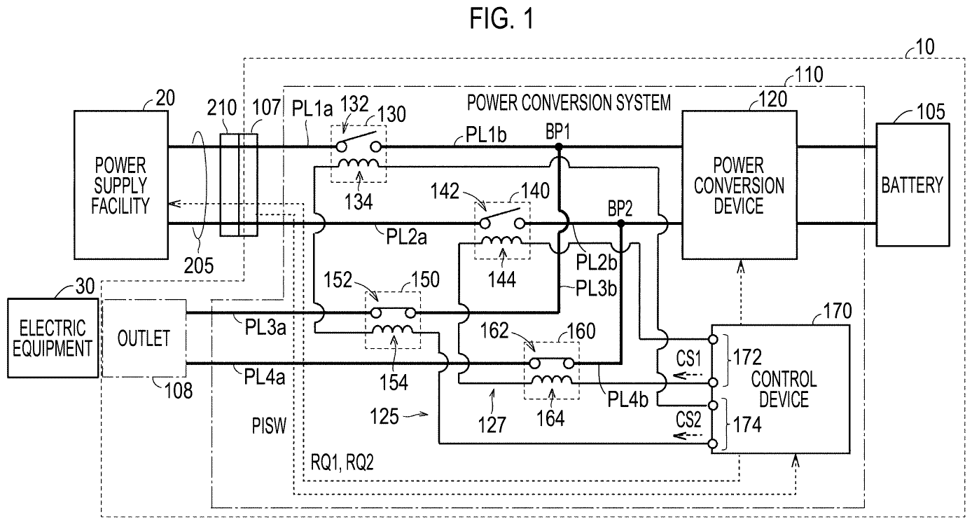

FIG. 1 is an overall configuration diagram of a vehicle on which a power conversion system according to an embodiment is mounted. With reference to FIG. 1, the vehicle 10 includes a battery 105, an inlet 107, an outlet 108, and a power conversion system 110.

The battery 105 is a power storage device that stores power for traveling of the vehicle 10, and is a rechargeable secondary battery, such as a lithium ion battery. The stored amount of electricity of the battery 105 is represented by, for example, a state of charge (SOC).

The inlet 107 is a power receiving port that receives the supply power from the power supply facility 20 outside the vehicle 10 through the charging cable 205 and the connector 210. The inlet 107 outputs the signal PISW. The signal PISW indicates a connection state (connection/non-connection) between the connector 210 and the inlet 107. The supply power may be any of alternating current power or direct current power. In a case where the supply power is alternating current power, the voltage of the supply power is, for example, 200 V. In a case where the supply power is direct current power, the voltage is, for example, 400 V or 800 V.

The outlet 108 is installed in the vehicle cabin of the vehicle 10, and the electric equipment 30 is connected to the outlet 108. The electric equipment 30 is electric equipment different from a component of the vehicle 10, and is, for example, a home appliance that operates by receiving 100 V of alternating current power.

The power conversion system 110 is connected to the battery 105. The power conversion system 110 includes a power conversion device 120, relay circuits 125, 127, and a control device 170.

The power conversion device 120 is a bidirectional power conversion device. The power conversion device 120 converts the power received by the inlet 107 to charge the battery 105 (external charging) in a case where the contact relays 130, 140 (described below) are in a closed state. Alternatively, the power conversion device 120 converts the power of the battery 105 and supplies the converted power to the outlet 108 in a case where the contact relays 150, 160 (described below) are in a closed state. As a result, the power after the conversion is supplied to the electric equipment 30 through the outlet 108. The power supply from the vehicle 10 to the outside (in this example, the electric equipment 30) is also referred to as “external power supply”. As described above, the power conversion device 120 can execute both the external charging and the external power supply with one device.

The relay circuit 125 includes contact relays 130, 150. The contact relay 130 includes an electric contact 132 and a coil 134. The electric contact 132 corresponds to a switch connected between the power lines PL1a, PL1b. The contact relay 150 includes an electric contact 152 and a coil 154. The electric contact 152 corresponds to a switch connected between the power lines PL3a, PL3b. The coil 154 is connected to the coil 134. The power line PL3b branches from the power line PL1b at a branch point BP1.

The relay circuit 127 includes contact relays 140, 160. The contact relay 140 includes an electric contact 142 and a coil 144. The electric contact 142 corresponds to a switch connected between the power lines PL2a, PL2b. The electric contact 142 is provided in parallel with the electric contact 132 to a first power supply line (described later). The contact relay 160 includes an electric contact 162 and a coil 164. The electric contact 162 corresponds to a switch connected between the power lines PL4a, PL4b. The electric contact 162 is provided in parallel with the electric contact 152 to a second power supply line (described later). The coil 164 is connected to the coil 144. The power line PL4b branches from the power line PL2b at a branch point BP2.

Each of the contact relays 130, 140, 150, 160 further includes an iron core (not shown) wound around the coil. Each of the contact relays 130, 140 is a normally open contact relay (a contact relay). Each of the contact relays 150, 160 is a normally closed contact relay (b-contact relay).

The electric contacts 132, 142, 152, 162 are turned on and off in accordance with the applied voltage to the coils 134, 144, 154, 164, respectively. For example, in the contact relay 130 (150), when the voltage applied to the coil 134 (154) exceeds the operation voltage of the contact relay 130 (150), the electric contact 132 (152) is turned on (off). When the applied voltage is lower than the return voltage of the contact relay 130 (150), the electric contact 132 is turned off (on). The same applies to the contact relays 140, 160. In the following description, it is assumed that the operation voltage of the contact relays 130, 140, 150, 160 is the same and the return voltage of the contact relays is the same. The return voltage is higher than zero voltage (0 V) and lower than the operating voltage.

In the following description, the “open state” of the contact relays 130, 140, 150, 160 refers to a state in which the electric contacts 132, 142, 152, 162 are turned off, respectively. The “closed state” of the contact relays 130, 140, 150, 160 means a state in which the electric contacts 132, 142, 152, 162 are turned on, respectively. During the external charging, it is preferable that the contact relays 130, 140 are controlled to be in the closed state, and the contact relays 150, 160 are controlled to be in the open state.

The term “open” the contact relays 130, 140, 150, 160 means switching the contact relays from the closed state to the open state. The “closing” of the contact relays 130, 140, 150, 160 means switching the contact relays from the open state to the closed state.

The driving of the contact relays 130, 140 (normally open contact relays) means switching the open or closed state of each of the contact relays 130, 140 from the open state to the closed state. The open state of the contact relays 130, 140 corresponds to a state in which the relays are not driven (non-driven state). The closed state of the contact relays 130, 140 corresponds to a state in which the relays are driven (driven state). The non-driven state and the driven state are collectively referred to as an “operation state”.

The driving of the contact relays 150, 160 (normally closed contact relay) means switching the open or closed state of each of the contact relays 150, 160 from the closed state to the open state. The closed state of the contact relays 150, 160 corresponds to the non-driven state of the relays. The open state of the contact relays 150, 160 corresponds to the driven state of the relays.

The power supply line extending from the inlet 107 to the power conversion device 120 is also referred to as a “first power supply line”. The first power supply line corresponds to a power transmission path constituted by the power lines PL1a, PL2a, the contact relays 130, 140, and the power lines PL1b, PL2b.

A power supply line extending from the power lines PL1b, PL2b to the outlet 108 among the first power supply lines is also referred to as a “second power supply line”. The second power supply line corresponds to a power transmission path constituted by the power lines PL3a, PL4a, the contact relays 150, 160, and the power lines PL3b, PL4b.

The control device 170 has terminal pairs 172, 174. The terminal pair 172 is connected to the relay circuit 127. The terminal pair 174 is connected to the relay circuit 125.

The control device 170 controls each of the devices of the vehicle 10. The control device 170 controls, for example, the power conversion device 120. The control device 170 generates the control signal CS1 to control the open or closed states of the contact relays 140, 160. The control device 170 generates the control signal CS2 to control the open or closed states of the contact relays 130, 150.

The control signal CS1 is a voltage signal having a value of a voltage applied to the terminal pair 172 as a signal value. Voltages are applied to each of the coils 144, 164 due to the control signal CS1. A signal value of the control signal CS1 is switched between a logic high (H) level and a logic low (L) level.

In a case where the signal value is the H level, the applied voltages to the coils 144, 164 are higher than the operation voltages of the contact relays 140, 160, respectively. For example, when the control signal CS1 is switched from the L level to the H level, the applied voltages to the coils 144, 164 exceed the operation voltages of the contact relays 140, 160, respectively. As a result, the operation state of each of the contact relays is switched from the non-driven state to the driven state, so that the contact relay 140 is closed and the contact relay 160 is opened.

On the other hand, in a case where the signal value of the control signal CS1 is the L level, the applied voltages to the coils 144, 164 are lower than the return voltages of the contact relays 140, 160, respectively. For example, when the control signal CS1 is switched from the H level to the L level, the applied voltages to the coils 144, 164 are lower than the return voltages of the contact relays 140, 160, respectively. As a result, the operation state of each of the contact relays is switched from the driven state to the non-driven state, so that the contact relay 140 is opened and the contact relay 160 is closed.

As described above, the control signal CS1 is a signal for controlling the operation states of both the contact relays 140, 160 solely. In other words, the operation states of the contact relays 140, 160 are controlled at the same time in accordance with a single control signal CS1 in the same relay circuit 127. As a result, the contact relays 140, 160 are complementarily turned on and off in response to the switching of the signal value of the control signal CS1.

The control signal CS2 is a voltage signal having a value of a voltage applied to the terminal pair 174 as a signal value. Voltages are applied to each of the coils 134, 154 due to the control signal CS2. A signal value of the control signal CS2 is switched between the H level and the L level.

In a case where the signal value is the H level, the applied voltages to the coils 134, 154 are higher than the operation voltages of the contact relays 130, 150, respectively. For example, when the control signal CS2 is switched from the L level to the H level, the applied voltages to the coils 134, 154 respectively exceed the operation voltage of the contact relays 130, 150. As a result, the operation state of each of the contact relays is switched from the non-driven state to the driven state, so that the contact relay 130 is closed and the contact relay 150 is opened.

On the other hand, in a case where the signal value of the control signal CS2 is the L level, the applied voltages to the coils 134, 154 are lower than the return voltages of the contact relays 130, 150, respectively. For example, when the control signal CS2 is switched from the H level to the L level, the applied voltage to each of the coils 134, 154 is lower than the return voltage of the contact relays 130, 150. As a result, the operation state of each of the contact relays is switched from the driven state to the non-driven state, so that the contact relay 130 is opened and the contact relay 150 is closed.

As described above, the control signal CS2 is a signal for controlling the operation states of both the contact relays 130, 150 solely. In other words, the operation states of the contact relays 130, 150 are controlled at the same time in accordance with a single control signal CS2 in the same relay circuit 125. As a result, the contact relays 130, 150 are complementarily turned on and off in response to the switching of the signal value of the control signal CS2.

The control device 170 can communicate with the power supply facility 20 by CAN (Controller Area Network) communication or the like when the connector 210 is connected to the inlet 107. The control device 170 generates, for example, a power supply start request RQ1 and transmits the power supply start request RQ1 to the power supply facility 20. As a result, the supply power is supplied from the power supply facility 20 to the vehicle 10, and the external charging is started. During the external charging, the control device 170 basically controls the control signals CS1, CS2 to the H level to control the contact relays 130, 140 to the closed state to maintain the first power supply line in the conducting state. When the SOC of the battery 105 reaches a predetermined target value (for example, 80%), the control device 170 generates a power supply stop request RQ2 and transmits the power supply stop request RQ2 to the power supply facility 20. As a result, the supply of the supply power from the power supply facility 20 to the vehicle 10 is stopped, and the external charging ends.

During the external charging, it is preferable to control the contact relays 130, 140 to be in the closed state to maintain the first power supply line in the conducting state, and to control the contact relays 150, 160 to be in the open state to make the second power supply line in the non-conducting state. This is because the voltage of the supply power from the power supply facility 20 is different from the operating voltage of the electric equipment 30, and thus the connector 210 is electrically connected to the outlet 108 to prevent the voltage of the supply power from the power supply facility 20 from being applied to the electric equipment 30 unintentionally.

There is a possibility that an abnormality may occur in a control system that controls the contact relays 150, 160 unintentionally. It is not preferable that the abnormality causes at least any one of the contact relays 150, 160 to malfunction during the external charging and to be unintentionally closed. In this case, both the first and second power supply lines can be brought into a conducting state, and the connector 210 and the outlet 108 can be electrically connected to each other. As a result, there is a possibility that the voltage of the supply power is applied to the electric equipment 30 unintentionally. In this case, there is a possibility that the electric equipment 30 cannot be protected from the voltage of the supply power.

On the other hand, with the power conversion system 110 according to the embodiment, it is possible to cope with such a problem. Hereinafter, this point will be described.

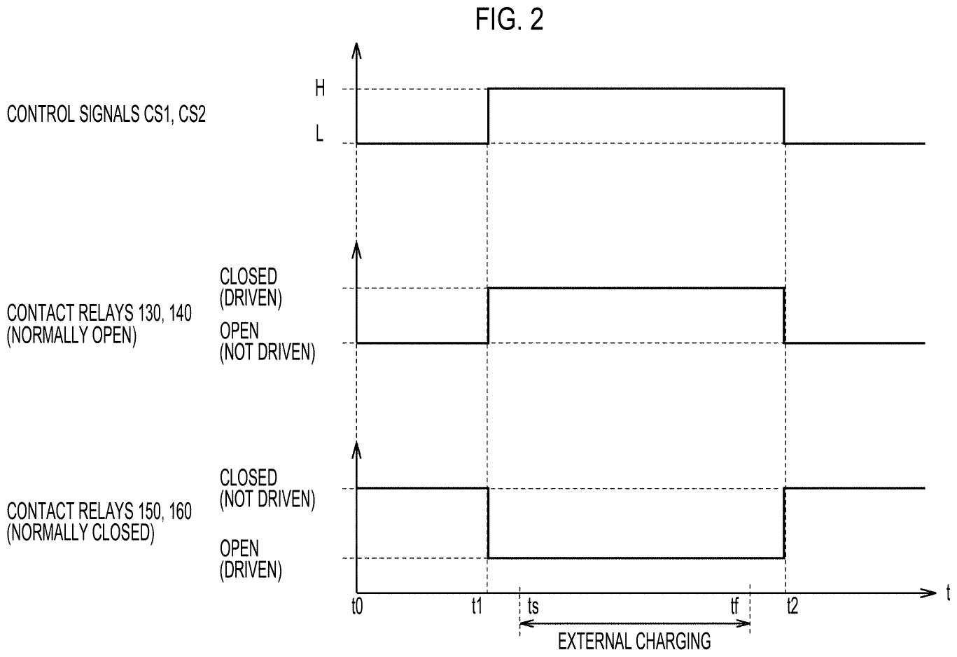

FIGS. 2 to 5 are diagrams for describing an example of the transition of the signal values of the control signals CS1, CS2 and the open or closed states of the contact relays 130, 140, 150, 160.

With reference to FIG. 2, at time t0, the control device 170 determines that the connector 210 is connected to the inlet 107 based on the signal PISW. The signal values of the control signals CS1, CS2 are both L levels.

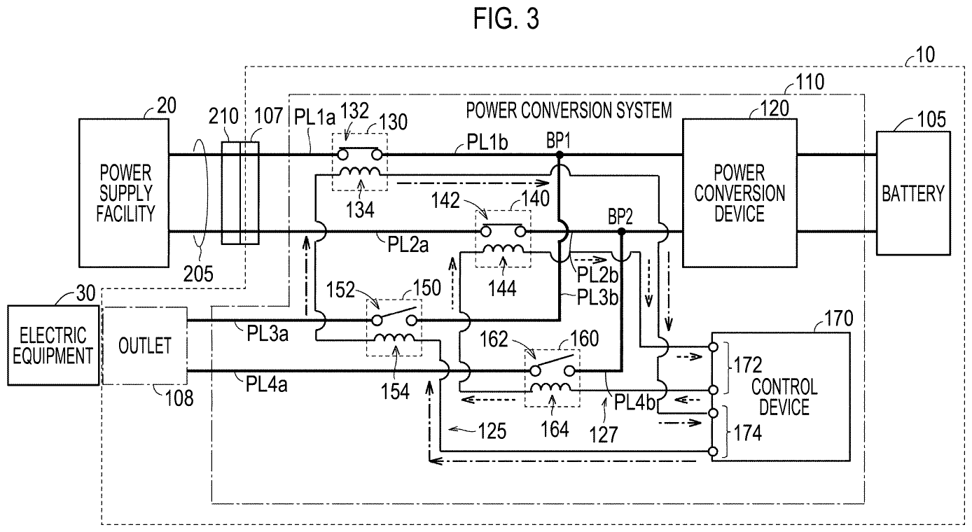

Thereafter, at time t1, the control device 170 switches the signal value of the control signal CS1 from the L level to the H level. As a result, the applied voltage to each of the coils 144, 164 exceeds the operation voltage of the contact relays 140, 160. As a result, the operation state of the contact relays is switched from the non-driven state to the driven state. Therefore, the contact relay 160 is opened while the contact relay 140 is closed (see FIG. 3).

At time t1, the control device 170 switches the control signal CS2 from the L level to the H level. As a result, the applied voltage to each of the coils 134, 154 exceeds the operation voltage of the contact relays 130, 150. As a result, the operation state of the contact relays is switched from the non-driven state to the driven state. Therefore, the contact relay 150 is opened while the contact relay 130 is closed (see FIG. 3).

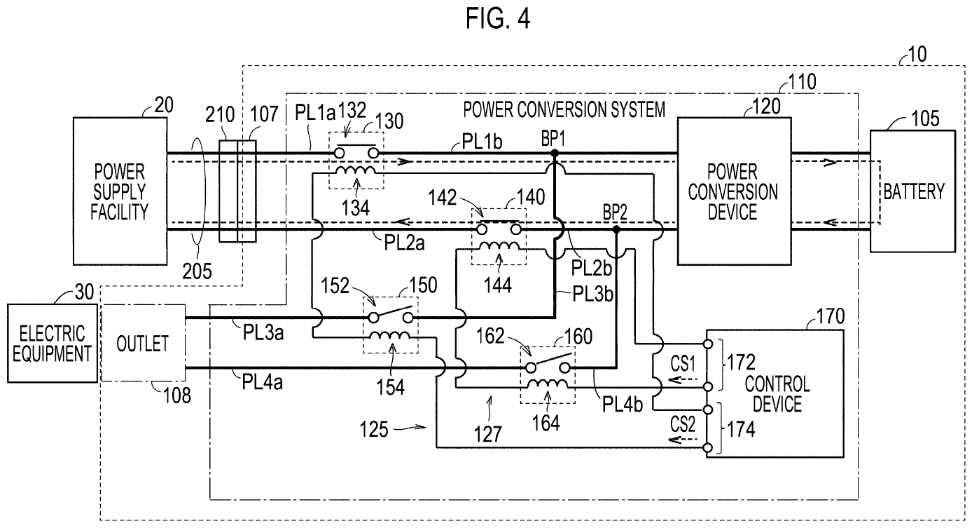

At time ts, the control device 170 transmits the power supply start request RQ1 to the power supply facility 20 to start the external charging. As a result, the supply power is supplied to the power conversion device 120 in a state where the contact relays 130, 140 are in the closed state and the contact relays 150, 160 are in the open state. As a result, the external charging is executed while ensuring the electric insulation between the connector 210 and the outlet 108 (see FIG. 4). When the SOC reaches the target value at time tf, the control device 170 transmits the power supply stop request RQ2 to the power supply facility 20 to end the external charging.

At time t2, the control device 170 switches the signal value of the control signal CS1 from the H level to the L level. As a result, the applied voltage to each of the coils 144, 164 is lower than the return voltage of the contact relays 140, 160. As a result, the operation state of the contact relays is switched from the driven state to the non-driven state. Therefore, the contact relay 160 is closed while the contact relay 140 is opened.

At time t2, the control device 170 switches the signal value of the control signal CS2 from the H level to the L level. As a result, the applied voltage to each of the coils 134, 154 is lower than the return voltage of the contact relays 130, 150. As a result, the operation state of the contact relays is switched from the driven state to the non-driven state. Therefore, the contact relay 150 is closed while the contact relay 130 is opened.

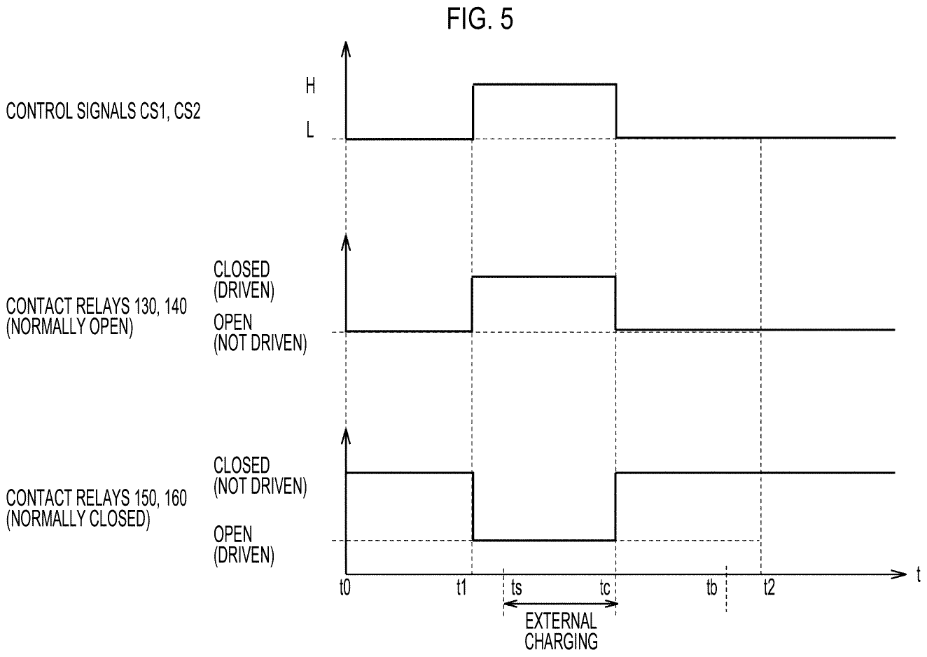

With reference to FIG. 5, in this example, at time tc before the SOC reaches the target value during the external charging, the signal values of the control signals CS1, CS2 change from the H level to the L level due to the abnormality of the control device 170. As a result, the contact relays 150, 160 are closed unintentionally. However, even in such a case, the contact relay 130 is opened in response to a change in the signal value of the control signal CS2, and the contact relay 140 is opened in response to a change in the signal value of the control signal CS1.

As described above, even in a case of an abnormality of the control device 170, the open or closed states of the contact relays 140, 160 are switched complementarily to each other according to the single control signal CS1, and the open or closed states of the contact relays 130, 150 are also switched complementarily to each other according to the single control signal CS2. Therefore, when the external charging is performed, a situation in which the contact relays 130, 140, 150, 160 are in the closed state at the same time is avoided. Therefore, even in a case where the abnormality of the control device 170 occurs unintentionally during the external charging, the voltage of the supply power can be prevented from being applied to the electric equipment 30 through the outlet 108. Therefore, the electric equipment 30 can be appropriately protected from the voltage of the supply power.

The control device 170 can generate solely one of the control signals CS1, CS2 to control the contact relays 130, 150 or the contact relays 140, 160 to protect the electric equipment 30 (details will be described later). In the embodiment, the signal values of the control signals CS1, CS2 are set in coordination with each other as described above. For example, when the signal value of the control signal CS1 is set to the H level such that the contact relays 140, 160 are driven, the control device 170 also sets the signal value of the control signal CS2 to the H level such that the contact relays 130, 150 are driven. Alternatively, in a case where the signal value of the control signal CS1 is set to the L level such that the contact relays 140, 160 are not driven, the control device 170 sets the signal value of the control signal CS2 to the L level such that the contact relays 130, 150 are not driven.

The signal values are set in coordination with each other as described above. As a result, even in a case where at least one of the contact relays 140, 160 is welded and thus both of the contact relays are in the closed state, the contact relays 130, 150 are complementarily turned on and off in response to the control signal CS2. As a result, since one of the contact relays 130, 150 is in the open state, all of the contact relays 130, 140, 150, 160 are not brought into the closed state at the same time.

Alternatively, the signal values are set in coordination with each other as described above. As a result, even in a case where at least one of the contact relays 130, 150 is welded and thus both of the contact relays are in the closed state, the contact relays 140, 160 are complementarily turned on and off in response to the control signal CS1. As a result, since one of the contact relays 140, 160 is in the open state, all of the contact relays 130, 140, 150, 160 are not brought into the closed state at the same time.

Therefore, in the embodiment, even in a case where any of the contact relays 130, 140, 150, 160 is welded, the connector 210 and the outlet 108 can be effectively insulated during external charging. Therefore, the electric equipment 30 can be effectively protected from the voltage of the supply power.

According to the embodiment, even in a case where the signal values of the control signals CS1, CS2 are changed due to the abnormality of the control device 170 during the external charging, the voltage of the supply power is prevented from being applied to the electric equipment 30 through the outlet 108 without intention. As a result, the electric equipment 30 can be appropriately protected from the voltage of the supply power during the external charging.

### Modification 1

In the embodiment, the operation time of each of the contact relays 130, 140, 150, 160 is not considered. The operation time of the contact relay refers to a time from when a voltage higher than an operation voltage of the contact relay (for example, a rated voltage) is applied to a coil of the contact relay to when the contact relay is driven. However, in practice, it is preferable to take into consideration the operation time of each of the contact relays, and the operation time depends on the configuration of the contact relay. For example, the thicker the core of the coil of the contact relay, the shorter the operation time of the contact relay.

In the modification 1, the contact relays 150, 160 (normally closed contact relay) are configured such that the operation time of each of the contact relays 150, 160 is shorter than the operation time of each of the contact relays 130, 140 (normally open contact relay). For example, the core of each of the contact relays 150, 160 is thicker than the core of each of the contact relays 130, 140.

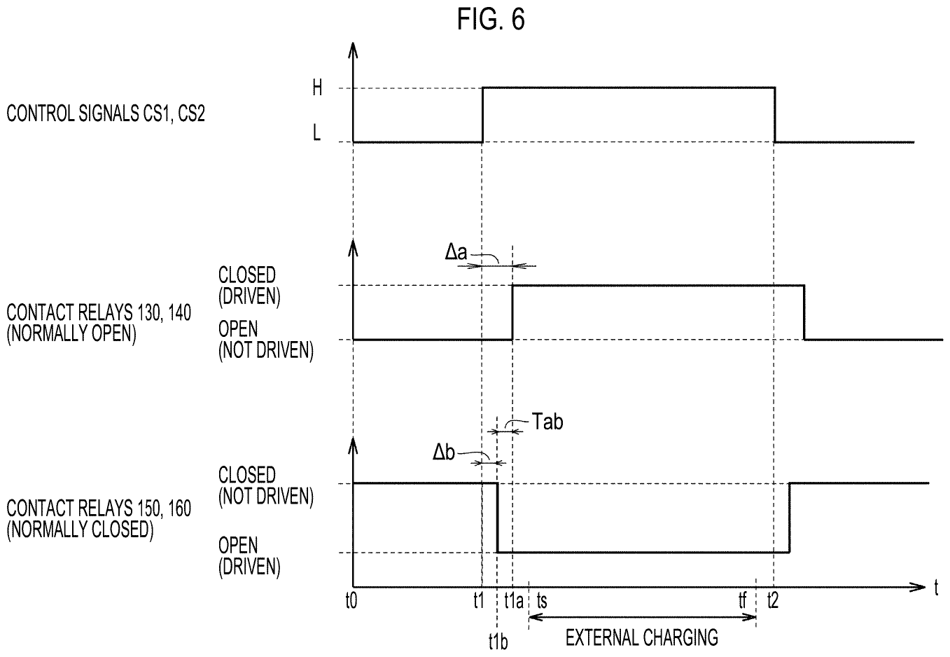

FIG. 6 is a diagram for describing another example of the transition of the signal values of the control signals CS1, CS2 and the open or closed states of the contact relays 130, 140, 150, 160. Times t0, t1, t2, ts, and tf are the same as those shown in FIG. 2.

With reference to FIG. 6, the operation time Δa is the operation time of the contact relays 130, 140. The operation time Δb is the operation time of the contact relays 150, 160.

Time t1a is a time later than time t1 by the operation time Δa. At time t1a, the contact relays 130, 140 are driven and closed. Time t1b is a time when an operation time Δb has elapsed from time t1. At time t1b, the contact relays 150, 160 are driven and opened.

The operation time Δb is shorter than the operation time Δa. As a result, after both the signal values of the control signals CS1, CS2 are switched from the L level to the H level at time t1, the contact relays 150, 160 are driven and opened earlier than the contact relays 130, 140 (time t1b). As a result, during the period Tab from time t1b to time t1a, all of the contact relays 130, 140, 150, 160 are in the open state. Then, after the contact relays 130, 140 are driven and closed at time t1a, the external charging is started. Therefore, after the connector 210 and the outlet 108 are more reliably electrically insulated, the external charging is started. As a result, the voltage of the supply power is more effectively prevented from being applied to the electric equipment 30. Therefore, the electric equipment 30 can be more appropriately protected from the voltage of the supply power. It should be noted that after time t2, the external charging has already been terminated, and the voltage from the outside is not applied to the first power supply line. Therefore, there is no problem even when the contact relays 150, 160 are closed earlier than the contact relays 130, 140 after time t2.

According to the modification 1, even in a case where the signal values of the control signals CS1, CS2 are changed unintentionally before the start of the external charging, the contact relays 150, 160 are driven and opened earlier than the contact relays 130, 140. As a result, after the situation in which all of the contact relays 130, 140, 150, 160 are in the open state continues for a certain time, the contact relays 130, 140 are closed. Therefore, even in a case where the signal values of the control signals CS1, CS2 are changed unintentionally before the start of the external charging, the connector 210 and the outlet 108 can be more effectively insulated from each other and the power supply to the electric equipment 30 can be appropriately protected from the voltage of the supply power.

### Modification 2

In the above, (1) it is assumed that each of the contact relays 130, 140 is a normally open contact relay, and each of the contact relays 150, 160 is a normally closed contact relay. On the other hand, (2) each of the contact relays 130, 140 may be a normally closed contact relay, and each of the contact relays 150, 160 may be a normally open contact relay.

As described above, one of the contact relays 130, 140 and the contact relays 150, 160 may be a normally open contact relay, and the other may be a normally closed contact relay. As a result, in any of the cases of (1) and (2), the contact relays 140, 160 are opened and closed complementarily to each other in response to the change in the signal value of the control signal CS1. Further, the contact relays 130, 150 are opened and closed complementarily to each other in response to a change in the signal value of the control signal CS2.

In a case of (2), the control device 170 sets both the signal values of the control signals CS1, CS2 to the L level at the time of the external charging. As a result, the external charging is executed in a state where the contact relays 130, 140 are in the closed state and the contact relays 150, 160 are in the open state. As a result, the electric equipment 30 can be appropriately protected from the voltage of the supply power during the external charging. In addition, even in a case where the signal values of the control signals CS1, CS2 are changed unintentionally during the external charging, the contact relays 140, 160 are complementarily turned on and off in response to the change in the signal value of the control signal CS1. Further, the contact relays 130, 150 are complementarily turned on and off in response to a change in the signal value of the control signal CS2. Therefore, a situation in which the contact relays 130, 140, 150, 160 are in the closed state at the same time is avoided. Therefore, as in the embodiment, it is possible to prevent the voltage of the supply power from being unintentionally applied to the electric equipment 30 during the external charging.

Modifications 1, 2 may be appropriately combined. For example, in the case of (2), the contact relays 130, 140 (normally closed contact relay) may be configured such that the operation time of the contact relays 130, 140 is shorter than the operation time of the contact relays 150, 160 (normally open contact relay).

### Modification 3

Referring to FIG. 1 again, in the above, the power conversion system 110 includes both the relay circuits 125, 127, but may include solely one of the contact relay circuits. In this case, the control device 170 generates solely one of the control signals CS1, CS2.

For example, in a case where the power conversion system 110 includes solely the relay circuit 125 among the relay circuits 125, 127, the control device 170 generates solely the control signal CS2 among the control signals CS1, CS2. The control device 170 switches the signal value of the control signal CS2 from the L level to the H level at the time of the start of the external charging. As a result, the contact relay 150 is opened while the contact relay 130 is closed. As a result, the external charging is executed in a state where the contact relay 130 is in the closed state and the contact relay 150 is in the open state.

Alternatively, in a case where the power conversion system 110 includes solely the relay circuit 127 (FIG. 1) of the relay circuits 125, 127, the control device 170 generates solely the control signal CS1 among the control signals CS1, CS2. The control device 170 switches the signal value of the control signal CS1 from the L level to the H level at the time of the start of the external charging. As a result, the contact relay 140 is driven to be closed, while the contact relay 160 is driven to be opened. As a result, the external charging is executed in a state where the contact relay 140 is in the closed state and the contact relay 160 is in the open state.

Also in the modification 3, the contact relays 130, 150 are controlled in accordance with the single control signal CS2 in the same relay circuit 125, and the closed state is prevented from being set at the same time. Alternatively, the contact relays 140, 160 are controlled in accordance with a single control signal CS1 in the same relay circuit 127, and the closed state is prevented from being set at the same time. As a result, even in a case where the signal value of the control signal CS1 or CS2 is changed unintentionally during the external charging, the voltage of the supply power is prevented from being applied unintentionally to the electric equipment 30 through the outlet 108. From the above, according to the modification 3, it is possible to appropriately protect the electric equipment 30 from the voltage of the supply power at the time of external charging while the number of components of the power conversion system 110 is reduced.

The embodiments disclosed herein should be considered merely illustrative and not restrictive in all respects. The scope of the disclosure is shown by the scope of claims rather than the above description, and is intended to include all modifications within the meaning and scope equivalent to the scope of claims.

What is claimed is:

1. A power conversion system mounted on a vehicle, the power conversion system comprising:
a power receiving port configured to receive power supplied from outside the vehicle;
a power supply port to which electric equipment is connected;
a power conversion device configured to convert the power received by the power receiving port to charge a power storage device of the vehicle or convert power of the power storage device to supply the power to the power supply port, the power conversion device being bidirectional;
a first switch provided in a first power supply line extending from the power receiving port to the power conversion device;
a second switch provided in a second power supply line extending from a portion of the first power supply line between the first switch and the power conversion device to the power supply port, the second switch being configured to be opened and closed complementarily to the first switch; and
a control device configured to generate a first control signal for controlling operation states of both the first switch and the second switch.

2. The power conversion system according to claim 1, wherein:
one of the first switch and the second switch is a first contact relay as a normally open contact relay; and
the other of the first switch and the second switch is a second contact relay as a normally closed contact relay.

3. The power conversion system according to claim 2, wherein the second contact relay is configured such that an operation time of the second contact relay is shorter than an operation time of the first contact relay.

4. The power conversion system according to claim 2, wherein:
the first switch is the first contact relay; and
the second switch is the second contact relay.

5. The power conversion system according to claim 2, further comprising:
a third switch provided in the first power supply line in parallel with the first switch electrically; and
a fourth switch provided in the second power supply line in parallel with the second switch electrically, the fourth switch being configured to be opened and closed complementarily to the third switch, wherein:
in a case where the first switch is the first contact relay and the second switch is the second contact relay,
the third switch is a third contact relay as a normally open contact relay different from the first contact relay, and
the fourth switch is a fourth contact relay as a normally closed contact relay different from the second contact relay;
in a case where the first switch is the second contact relay and the second switch is the first contact relay,
the third switch is the fourth contact relay, and
the fourth switch is the third contact relay;
the control device is configured to further generate a second control signal for controlling operation states of both the third contact relay and the fourth contact relay; and
the control device is configured to
set, in a case where a signal value of the first control signal is set such that both the first contact relay and the second contact relay are driven, a signal value of the second control signal such that both the third contact relay and the fourth contact relay are driven, and
set, in a case where the signal value of the first control signal is set such that both the first contact relay and the second contact relay are not driven, the signal value of the second control signal such that both the third contact relay and the fourth contact relay are not driven.
